(19) United States
(12) Patent Application Publication
(10) Pub. No.: US 2005/0105613 A1
(43) Pub. Date: May 19, 2005

(54) Method and device for coding and decoding a digital color video sequence

(76) Inventors: Gwenaelle Marquant, Liffre (FR); Stehane Edouard Valente, Paris (FR)

Correspondence Address: PHILIPS INTELLECTUAL PROPERTY & STANDARDS, P.O. BOX 3001, BRIARCLIFF MANOR, NY, 10510, US

(21) Appl. No.: 10/505,498

(22) PCT Filed: Feb. 12, 2003
(86) PCT No.: PCT/IB03/00567

(30) Foreign Application Priority Data
Feb. 28, 2002 (EP) 02290484.1

(51) Int. Cl. H04N 7/12

(52) U.S. Cl. 375/240.03; 375/240.18

(57) ABSTRACT

The invention relates to a method of coding an input digital video sequence corresponding to an original color image sequence, said method comprising at least a step for converting the video sequence from the spatial domain to less representation data, a quantizing step, for transforming the converted signals thus obtained into a reduced set of data, and a step for coding said quantized data. According to the invention, said coding method also comprises, before said converting step, a preprocessing step, provided for determining if the input video sequence is in the YUV color space and then transforming said YUV color space into a less redundant color space by means of a non-linear transformation.

### FIELD OF THE INVENTION

The present invention generally relates to video compression and, more particularly, to an original color image sequence represented by color space components defined in a first color space, said method comprising at least the following steps:
(1) a transforming step, for converting said first color space components corresponding to said input video sequence from the spatial domain to less representation data;
(2) a quantizing step, for transforming the converted signals thus obtained into a reduced set of data;
(3) an encoding step, for coding the quantized data thus obtained.

The invention also relates to the associated decoding method, to a corresponding encoder and decoder, and to a system comprising computer readable program codes for implementing said coding or decoding method.

### BACKGROUND OF THE INVENTION

Several studies, based on color-matching experiments, show that it is possible to completely parametrize the color space with three colors, provided they are linearly independent. The color space is thus a vectorial space of dimension 3, in which any test light can be expressed as a linear combination of three color-matching functions (=spectral distributions of the three primary lights). These color-matching functions are not unique, but it is possible to switch from one set of color-matching functions to another one by means of a change of basis using a linear transformation.

Data compression systems are well known: they operate on an original data stream and exploit the redundancies in the data, in order to reduce the size of these data to a compressed format generally more adapted to a transmission or storing operation. For these data, the red-green-blue (RGB) color space might be used, but this color space is severely redundant. The color space RGB can then be transformed into a so-called opponent color space, nominally white/black (or WB), red/green (or RG), and blue/yellow (or BY), using the following matrix (which corresponds to a linear transform):

$$[ \begin{matrix}WB \\ RG \\ BY\end{matrix} ] = [ \begin{matrix}0.4523 & 0.8724 & 0.1853 \\ 0.7976 & - 0.5499 & - 0.2477 \\ - 0.2946 & - 0.51329 & 0.8062\end{matrix} [ \begin{matrix}R \\ G \\ B\end{matrix} ]$$

(the opponent-colors theory, which states that some pairs of hues can coexist in a single color sensation while others cannot, is the basis of a technique for decorrelating information, said technique taking into account the fact that a spectral overlap exists between the sensitivity curves of the eye cones).

A decorrelation of the information indeed strongly simplifies a model of color perception since no inter-component masking phenomenon has then to be considered. In the case of a classical video approach, the video is preferably encoded along the three following separate channels: luminance (Y), chrominance (component U), chrominance (component V). In digital coding systems, either this (YUV) space or the (Y Cr Cb) space is used (it can be pointed out that U and V values range from −128 to 127, and Cr and Cb values from 0 to 255, these components being therefore connected by means of the relations U=Cr−128 and V=Cb−128). With such representation schemes, it seems however difficult to highly improve the rate/distorsion ratio.

### SUMMARY OF THE INVENTION

It is therefore a first object of the invention to propose an encoding method for the compression of a digital color video sequence, allowing to achieve a higher coding efficiency that the one obtained with the (Y, U, V) and (Y, Cr, Cb) representation schemes.

To this end, the invention relates to a coding method such as defined in the introductory part of the description and which is moreover characterized in that it also comprises:
(4) before the transforming step, a preprocessing step, for determining if said first color space of the input video sequence is the YUV color space and then transforming said YUV color space into a less redundant color space by means of a non-linear transformation.

It is also an object of the invention to propose a corresponding coding device.

It is still an object of the invention to propose a system comprising a computer usable medium having computer readable program code means embodied therein for implementing a digital video coding device provided for coding an input digital video sequence corresponding to an original color image sequence represented by color space components defined in a first color space, said computer readable program code means comprising the following computer readable program codes:
a program code for causing said computer to detect if said first color space of the input color video sequence is the YUV color space and then to transform said YUV color space into a less redundant color space;
a program code for causing said computer to convert said transformed sequence from the original spatial representation domain to a new representation domain;
a program code for causing said computer to perform a quantization of said converted sequence;
a program code for causing said computer to encode the quantized data thus obtained.

Another object of the invention is to propose a method allowing to decode the signals coded by means of the coding method according to the invention.

To this end, the invention relates to a method of decoding signals coded by means of a method of coding an input digital video sequence corresponding to an original color image sequence represented by color space components defined in a first color space, said coding method comprising at least the following steps:
(1) a transforming step, for converting said first color space components corresponding to said input video sequence from the spatial domain to less representation data;
(2) a quantizing step, for transforming the converted signals thus obtained into a reduced set of data;
(3) an encoding step, for coding the quantized data thus obtained;
(4) before said transforming step, a preprocessing step, for determining if said first color space of the input video sequence is the YUV color space and then transforming said YUV color space into a less redundant color space by means of a non-linear transformation,
   said decoding method comprising at least the following steps:
(1) a decoding step, for decoding said coded signals;
(2) an inverse quantizing step, for transforming the decoded signals thus obtained into dequantized signals;
(3) an inverse transforming step, for converting said dequantized signals to signals in the spatial domain;
   said decoding method being further characterized in that it also comprises:
(4) a post-processing step, for reconstructing from said signals in the spatial domain the original color image by means of the corresponding inverse non-linear transformation.

It is also an object of the invention to propose a corresponding decoding device.

It is still an object of the invention to propose a system comprising a computer usable medium having computer readable program code means embodied therein for implementing a digital video decoding device provided for decoding signals coded by means of a method of coding an input digital video sequence corresponding to an original color image sequence represented by color space components defined in a first color space, said coding method comprising at least the following steps:
(1) a transforming step, for converting said first color space components corresponding to said input video sequence from the spatial domain to less representation data;
(2) a quantizing step, for transforming the converted signals thus obtained into a reduced set of data;
(3) an encoding step, for coding the quantized data thus obtained;
(4) before said transforming step, a preprocessing step, for determining if said first color space of the input video sequence is the YUV color space and then transforming said YUV color space into a less redundant color space by means of a non-linear transformation;
   said computer readable program code means comprising the following computer readable program codes:
a program code for causing said computer to decode the coded signals;
a program code for causing said computer to perform an inverse quantization of the decoded signals thus obtained;
a program code for causing said computer to convert the dequantized signals thus obtained to signals in the spatial domain;
a program code for causing said computer to reconstruct from said signals converted in the spatial domain the original color image by means of the corresponding inverse non-linear transformation.

### BRIEF DESCRIPTION OF THE DRAWINGS

The invention will now be described in a more detailed manner, with reference to the accompanying drawings in which:

FIG. 1 depicts a coding device according to the invention;

FIG. 2 depicts a decoding device according to the invention.

### DETAILED DESCRIPTION OF THE INVENTION

According to the invention, each original frame of the obtained video sequence is preprocessed, before the encoding operation, by means of a non-linear transformation into a new space. The encoding operation is therefore now performed in this new representation space, an inverse transformation at the decoding side allowing to recover the frames in the original space and therefore the original true color images. For that preprocessing operation, several space representations can be used:
(a) first, the conventional space (Y, U, V) can be transformed, by means of a kind of normaization, into a new space (Y, Cr/Y, Cb/Y) or (Y, U/Y, V/Y), with U=R−Y and V=B−Y.
(b) such a space representation leading to a dynamic problem each time luminance values are greater that the chrominance ones, a scale factor s can be introduced, the new space being then (Y, s.U/Y, s.V/Y).
(c) another solution is to refer to hue (H), saturation (S) and luminance (Y, or L), these quantities, directly related to the human perception of light and color, being obtained with the following transforms:
Luminance (L)=Y
Hue (H)=arctan((B−Y)/(R−Y))=arctan (V/U)
Saturation (S)=\sqrt{(R−Y)²+(B−Y)²}=\sqrt{U²+V²}
R−Y=S.cosH
B−Y=S.sin H
   (d) a fourth solution is an alternative to the previous one (there is no further symmetry with respect to the color information, which lead to different values for hue and saturation parameters):
   Hue*=arctan (Cr/Cb)
   Saturation=\sqrt{Cr²+Cb²}

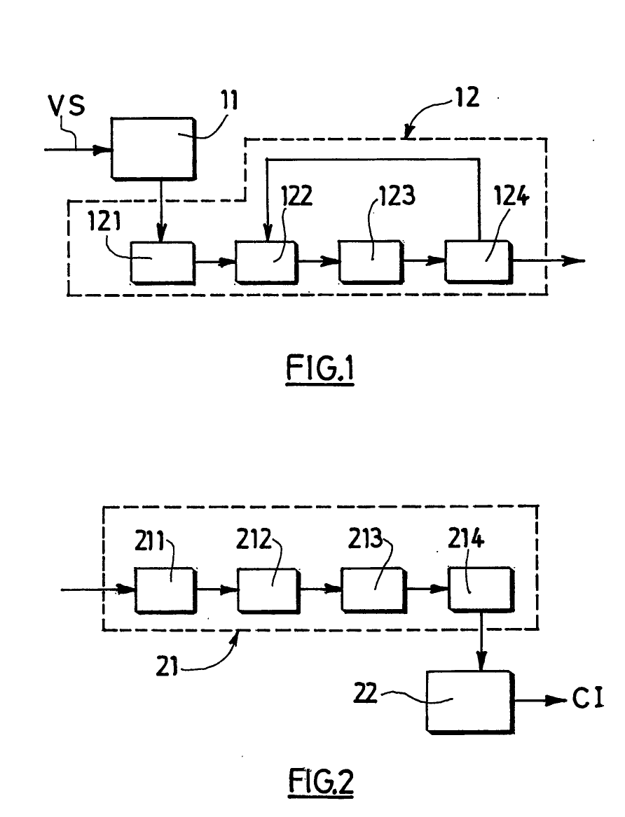

An example of implementation of a coding device for the compression of an input digital color video sequence will now be described. In the present embodiment, the data contained in the input video signal include pixel values which describe the color components (luminance signal Y, color difference signals U and V) of a corresponding location in the original images to which the video sequence corresponds. As shown in FIG. 1, this video sequence (video signal VS) is first presented to a preprocessor 11, the output of which is received by an encoder 12. The encoder 12 comprises for instance a DCT (discrete cosine transform) transform circuit 121, which linearly transforms blocks of 8×8 pixels into coefficients in the frequency domain, a quantizer 122, that receives the DCT coefficients thus obtained and performs their quantization, a variable length coder 123, that carries out the coding step of the quantized coefficients, and a rate controller 124, that stores the output signal of the coder 123 and sends to the quantizer 122 a feedback signal allowing to modify the quantization setting (such a rate controller generally comprises a buffer for receiving the coded bitstream and an updating circuit for generating an updated quantization setting).

The preprocessor 11 is provided for transforming the representation space (Y, U, V) into the new space. As said above, this non-linear transformation according to the invention may be performed in different ways, for instance the five following ones.

(A) Transformation into a Normalized Space.

The components Y, Cr, Cb ranging from 0 to 255, the idea consists in normalizing the (Y, Cr, Cb) space in a new space (Y, Cr/Y, Cb/Y), or (Y, U/Y, VIY) with U=Cr−128 and V=Cb−128, where U and V have been chosen to center the channel dynamics. With this transformation, more constant chrominance regions are obtained, owing to the suppression of lighting variations in each chrominance component (indeed, each component, now, only depends on the light source and the properties of the considered object).

(B) Transformation with Scale Factor.

With the above-mentioned transformation, a representation problem is raised each time luminance values are greater than the chrominance ones, because artefacts are introduced. It is then proposed, with respect to the previous transformation, to introduce an additional scale factor s. Given that, for low values of Y, the image is assumed to be highly dark, it is proposed to allocate no color (i.e. the value 128 for Cr and Cb, or 0 for U and V) to chrominance values as soon as the luminance value Y is lower than a threshold Yt. This allows to implement a new transformation T defined as:
if (Y<Yt), then {(Y, U, V)→(Y, 0, 0)}
else {(Y, U, V)→(Y, Yt .U/Y, Yt .V/Y)}
   Thanks to that modification, the chrominance channels in the transformed space remain colored while being less illuminated than the original ones, which allows, at the decoding side, to recover (after the inverse transformation) an image close to the original one. Without this modification, said inverse transformation might introduce artifacts: as soon as the luminance value is greater than the chrominance one, the transform value is set to 0 and, consequently, the inverse transformation is unable to recover a value close to the original one.

It may be noticed that the transformation from (Y, Cr, Cb) to (Y, Yt .U/Y Yt.V/Y) requires to tune Yt. However, experiments show that this threshold varies a lot according to the properties of the preprocessed sequence (for some sequences, some kinds of ringing appear below a given value of the threshold; for other ones, the dark limit is visible above the threshold; etc . . . ). An optimal quality rendering therefore requires an appropriate setting of the luminance threshold for each kind of sequence.

(C) Transformation into Another Type of Space.

In order to avoid such a complexity as previously described, a transformation in another representation space is then possible: it is proposed to encode the information in the channels (H, S, L), which refer to Hue, Saturation (or vividness) and Luminance (or intensity, or brightness), the color space employed by the human visual perception system. These quantities (H, S, L) are indeed directly related to the human perception. The L (or I) levels are simply the Y levels (the value of L indicates how bright the color is), while Hue, which represents the pure color, and Saturation, which indicates how little/how much gray is mixed in, are derived from the color difference values R−Y (=U) and B−Y (=V):
luminance L=Y
hue H=arctan ((B−Y)/(R−Y))=arctan (V/U)
saturation S=\sqrt{(R−Y)²+(B−Y)²=}\sqrt{U²+V²}
   the inverse transformations at the decoding side being:
R−Y=S.cosH
B−Y=S.sinH.

(D) An Alternative Solution to the Previous HSL One is:
Hue*=arctan (Cr/Cb)
Saturation*=\sqrt{Cr²+Cb²}
   (moreover, experiments show that these transformation and inverse transformation can be considered as a quasi-lossless process).

(E) Perceptual Transformation.

Perceptual studies have shown that human eyes cannot distinguish small luminance variations (1 to 5 grey levels). It has then been proposed to use less grey levels when compressing the luminance dynamic (for example 128 luminance grey levels instead of 256 ones, which is equivalent to a 7 bits luminance coding). Tests have shown that, if this luminance dynamic compression transformation/inverse transformation is applied to an image, human eyes cannot detect any variation between the original image and the reconstructed one.

At the decoding side, a decoding device, provided for implementing the above-mentioned inverse transformation, comprises, as shown in FIG. 2, a decoder 21 followed by a postprocessor 22 carrying out the inverse non-linear transformation allowing to recover the true color image CI. Said decoder, that receives the bitstream coded by means of the coding device described above, usually comprises a variable length decoder 211, an inverse quantization circuit 212, an inverse DCT circuit 213, and a reconstruction circuit 214.

The encoding and decoding devices, (11, 12) and (21, 22) respectively, can be implemented in a variety of ways to perform the functionalities described herein. In one embodiment, they may be embodied as software stored on media and executed by a general purpose or specifically configured computer system, typically including a central processing unit, a memory and one or more input/output devices and processors. Alternatively, they may be implemented as a combination of hardware, software or firmware, without excluding that a single item of hardware or software can carry out several functions or that an assembly of items of hardware or software or both carry out a single function. The described methods and devices may be implemented by any type of computer system or other apparatus adapted for carrying out the methods described herein, this computer system including a computer program that, when loaded and executed, controls the computer system such that it carries out the methods described herein.

Alternatively, a specific use computer, containing specialized hardware for carrying out one or more of the functional tasks of the invention, can be utilized. The present invention can also be embedded in a computer program product, which comprises all the features enabling the implementation of the methods and functions described herein, and which—when loaded in a computer system—is able to carry out these methods and functions. Computer program, software program, program, program product, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

1. A method of coding an input digital video sequence corresponding to an original color image sequence represented by color space components defined in a first color space, said method comprising at least the following steps:
(1) a transforming step, for converting said first color space components corresponding to said input video sequence from the spatial domain to less representation data;
(2) a quantizing step, for transforming the converted signals thus obtained into a reduced set of data;
(3) an encoding step, for coding the quantized data thus obtained;
said coding method being further characterized in that it also comprises:
(4) before the transforming step, a preprocessing step, for determining if said first color space of the input video sequence is the YUV color space and then transforming said YUV color space into a less redundant color space by means of a non-linear transformation.

2. A device for coding an input digital video sequence corresponding to an original color image sequence represented by color space components defined in a first color space, said device comprising at least:
(1) transforming means, for converting said first color space components corresponding to said input video sequence from the spatial domain to less representation data;
(2) quantizing means, for transforming the converted signals thus obtained into a reduced set of data;
(3) encoding means, for coding the quantized data thus obtained;
said coding device being further characterized in that it also comprises:
(4) before said transforming means, preprocessing means, for determining if said first color space of the input video sequence is the YUV color space and then transforming said YUV color space into a less redundant color space by means of a non-linear transformation.

3. A system comprising a computer usable medium having computer readable program code means embodied therein for implementing a digital video coding device provided for coding an input digital video sequence corresponding to an original color image sequence represented by color space components defined in a first color space, said computer readable program code means comprising the following computer readable program codes:
a program code for causing said computer to detect if said first color space of the input color video sequence is the YUV color space and then to transform said YUV color space into a less redundant color space;
a program code for causing said computer to convert said transformed sequence from the original spatial representation domain to a new representation domain;
a program code for causing said computer to perform a quantization of said converted sequence;
a program code for causing said computer to encode the quantized data thus obtained.

4. A method of decoding signals coded by means of a method of coding an input digital video sequence corresponding to an original color image sequence represented by color space components defined in a first color space, said coding method comprising at least the following steps:
(1) a transforming step, for converting said first color space components corresponding to said input video sequence from the spatial domain to less representation data;
(2) a quantizing step, for transforming the converted signals thus obtained into a reduced set of data;
(3) an encoding step, for coding the quantized data thus obtained;
(4) before the transforming step, a preprocessing step, for determining if said first color space of the input video sequence is the YUV color space and then transforming said YUV color space into a less redundant color space by means of a non-linear transformation;
said decoding method comprising at least the following steps:
(1) a decoding step, for decoding said coded signals;
(2) an inverse quantizing step, for transforming the decoded signals thus obtained into dequantized signals;
(3) an inverse transforming step, for converting said dequantized signals to signals in the spatial domain;
said decoding method being further characterized in that it also comprises:
(4) a post-processing step, for reconstructing from said signals in the spatial domain the original color image by means of the corresponding inverse non-linear transformation.

5. A device for decoding signals coded by means of a device for coding an input digital video sequence corresponding to an original color image sequence represented by color space components defined in a first color space, said coding device comprising at least:
(1) transforming means, for converting said first color space components corresponding to said input video sequence from the spatial domain to less representation data;
(2) quantizing means, for transforming the converted signals thus obtained into a reduced set of data;
(3) encoding means, for coding the quantized data thus obtained;
(4) before transforming means, preprocessing means, for determining if said first color space of the input video sequence is the YUV color space and then transforming said YUV color space into a less redundant color space by means of a non-linear transformation;
said decoding device comprising at least:
(1) decoding means, for decoding said coded signals;
(2) inverse quantizing means, for transforming the decoded signals thus obtained into dequantized signals;
(3) inverse transforming means, for converting said dequantized signals to signals in the spatial domain;
said decoding device being further characterized in that it also comprises
(4) post-processing means, for reconstructing from said signals converted in the spatial domain the original color image by means of the corresponding inverse non-linear transformation.

6. A system comprising a computer usable medium having computer readable program code means embodied therein for implementing a digital video decoding device provided for decoding signals coded by means of a method of coding an input digital video sequence corresponding to an original color image sequence represented by color space components defined in a first color space, said coding method comprising at least the following steps:
(1) a transforming step, for converting said first color space components corresponding to said input video sequence from the spatial domain to less representation data;
(2) a quantizing step, for transforming the converted signals thus obtained into a reduced set of data;
(3) an encoding step, for coding the quantized data thus obtained;
(4) before said transforming step, a preprocessing step, for determining if said first color space of the input video sequence is the YUV color space and then transforming said YUV color space into a less redundant color space by means of a non-linear transformation;
said computer readable program code means comprising the following computer readable program codes:
a program code for causing said computer to decode the coded signals;
a program code for causing said computer to perform an inverse quantization of the decoded signals thus obtained;
a program code for causing said computer to convert the dequantized signals thus obtained to signals in the spatial domain;
a program code for causing said computer to reconstruct from said signals converted in the spatial domain the original color image by means of the inverse corresponding non-linear transformation.
